(19) United States
(12) Patent Application Publication
(10) Pub. No.: US 2022/0053095 A1
(43) Pub. Date: Feb. 17, 2022

(54) ENTERPRISE TELEPHONY INTERCONNECT SERVICE

(71) Applicant: Cisco Technology, Inc., San Jose, CA (US)

(72) Inventors: Christopher Edwin Pearce, Dallas, TX (US); Mable Chiu, Plano, TX (US); Kameswar R. Ati, Fairview, TX (US); Susanna Liem, Irving, TX (US)

(21) Appl. No.: 16/993,501

(22) Filed: Aug. 14, 2020

(51) Int. Cl. H04M 7/00; H04M 1/253; H04L 29/06

(52) U.S. Cl. CPC H04M 7/006; H04L 65/1006; H04L 65/1069; H04M 1/2535

(57) ABSTRACT

In various embodiments, a mobile device connected to a cellular network performs a credential exchange with a telephone not connected to an Internet Protocol (IP) network. The mobile device relays, via the cellular network, registration information between the telephone and a telephony interconnect service, based in part on the credential exchange. The mobile device receives an indication of a telephone call associated with a user of the mobile device. The mobile device proxies, via the cellular network, the telephone call between the telephony interconnect service and the telephone.

### TECHNICAL FIELD

The present disclosure relates generally to computer networks, and, more particularly, to an enterprise telephony interconnect service.

### BACKGROUND

Enterprises are increasingly providing enterprise-enabled mobile phones to their employees. In contrast to traditional mobile phones, calls made by enterprise-enabled phones are sent by the carrier to a specialized application, referred to as an enterprise ‘call agent.’ In turn, the call agent provides a host of features to the phone, such as supporting a dialing pattern of the enterprise, call hunting, dialing-class-of-service, shared line status, and the like.

Many enterprises have offices, branches, campuses, and other locations distributed throughout the world. Thus, when a user travels between locations, their enterprise-enabled mobile phone may register with any number of different mobile carriers, each of which adheres to the legal requirements and regulations of its corresponding jurisdiction. In addition, the different locations of an enterprise may have desk phones that have a static association with a user or they may have desk phones used in a hot-desking situation, whereby nomadic users physically log into a desk phone, allowing that phone to take on the default settings of the user. However, not every location of an enterprise may have a reliable wired connection.

### BRIEF DESCRIPTION OF THE DRAWINGS

FIGS. 1A-1B illustrate an example communication network;

FIG. 2 illustrates an example network device/node;

FIG. 3 illustrates an example enterprise telephony system;

FIGS. 4A-4C illustrate an example of a mobile device interfacing with a telephone;

FIGS. 5A-5D illustrates an example of a mobile device proxying a call with a telephone; and

FIG. 6 illustrates an example simplified procedure for performing a telephone call.

### DESCRIPTION OF EXAMPLE EMBODIMENTS

### Overview

According to one or more embodiments of the disclosure, a mobile device connected to a cellular network performs a credential exchange with a telephone not connected to an Internet Protocol (IP) network. The mobile device relays, via the cellular network, registration information between the telephone and a telephony interconnect service, based in part on the credential exchange. The mobile device receives an indication of a telephone call associated with a user of the mobile device. The mobile device proxies, via the cellular network, the telephone call between the telephony interconnect service and the telephone.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

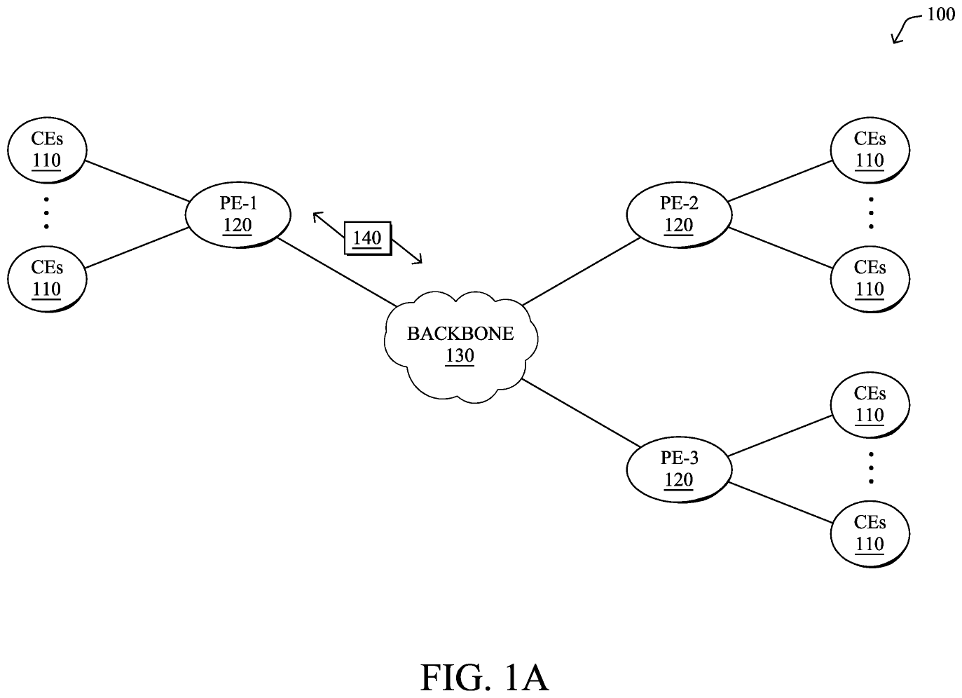

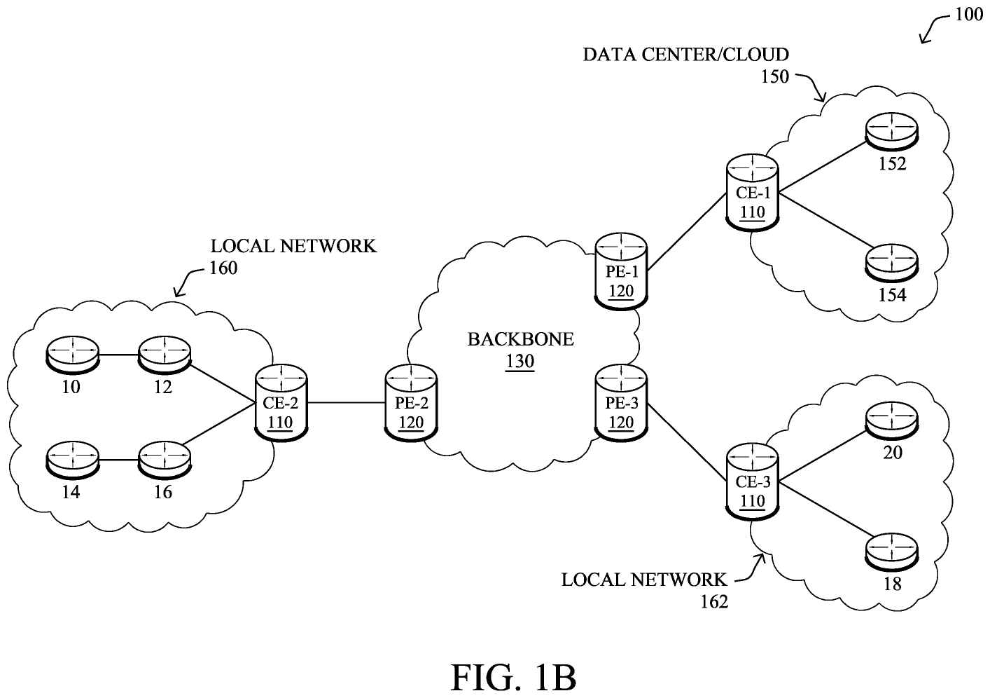

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

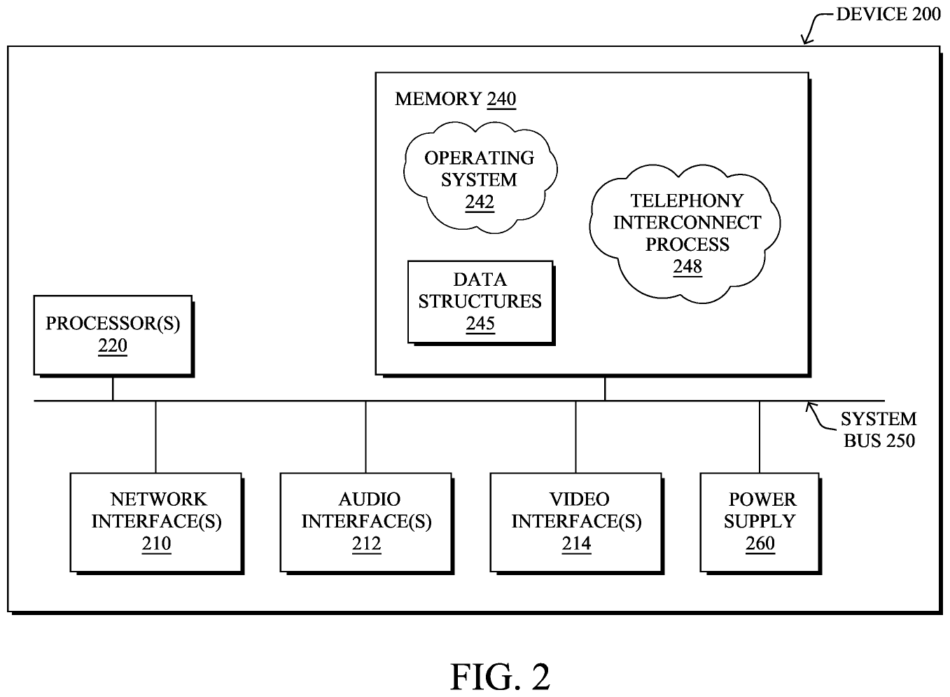

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. As shown, device 200 may comprise any or all of the following components: one or more network interfaces 210, one or more audio interfaces 212, one or more video interfaces 214, one or more processors 220, and/or a memory 240 interconnected by a system bus 250, and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The audio interface(s) 212 may include the mechanical, electrical, and signaling circuitry for transmitting and/or receiving audio signals to and from the physical area in which device 200 is located. For instance, audio interface(s) 212 may include one or more speakers and associated circuitry to generate and transmit soundwaves. Similarly, audio interface(s) 212 may include one or more microphones and associated circuitry to capture and process soundwaves.

The video interface(s) 214 may include the mechanical, electrical, and signaling circuitry for displaying and/or capturing video signals. For instance, video interface(s) 214 may include one or more display screens. Preferably, at least one of the display screens is a touch screen, such as a resistive touchscreen, a capacitive touchscreen, an optical touchscreen, or other form of touchscreen display, to allow a user to interact with device 200. In addition, video interface(s) 214 may include one or more cameras, allowing device 200 to capture video of a user for transmission to a remote device via network interface(s) 210. Such cameras may be mechanically controlled, in some instances, to allow for repositioning of the camera, automatically.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a telephony interconnect process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, enterprises are increasingly providing enterprise-enabled mobile phones and other devices to their employees. In contrast to traditional mobile phones, calls made by enterprise-enabled phones are sent by the carrier to a specialized application, referred to as an enterprise ‘call agent.’ In turn, the call agent provides a host of features to the phone, such as supporting a dialing pattern of the enterprise, call hunting, dialing-class-of-service, shared line status, and the like.

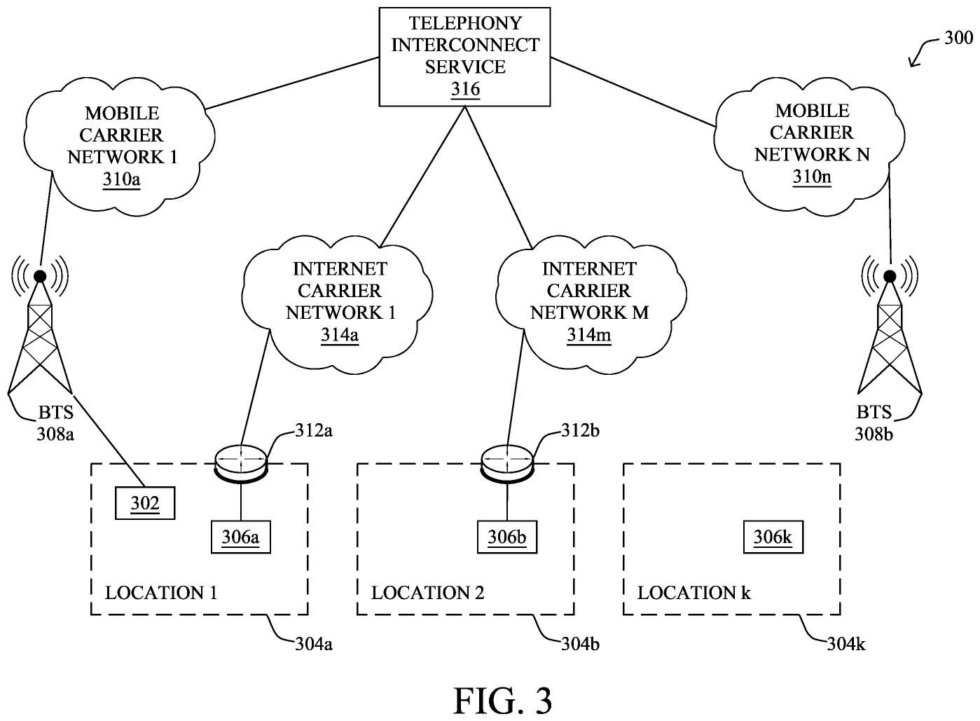

FIG. 3 illustrates an example enterprise telephony system 300, according to various embodiments. For a typical enterprise, there may be any number of locations 304 distributed throughout a geographic area or even across the world, such as locations 304a, 304b, and 304k shown (e.g., a first location, a second location, through a k^{th} location). For instance, locations 304 may include, but are not limited to, office buildings, branches, schools, hospitals, factories, and the like.

In many instances, each location 304 includes its own computing network infrastructure, such as switches, routers, firewalls, session border controllers (SBCs), and the like. These networking devices provide connectivity between the various devices located in the corresponding location 304 and one or more provider/carrier networks, such as Internet carrier networks 314a and 314b (e.g., a first through M^{th} network) via their respective routers 312a and 312b, allowing these devices to maintain a data connection, externally.

However, not every location 304 may have such infrastructure or have a reliable data connection with its provider. For instance, location 304k may not include any networking infrastructure to connect location 304k to a corresponding Internet carrier network. In other cases, the connection between location 304k and a corresponding Internet carrier network may be unreliable or prone to long, sporadic outages. As a result, while telephones 306a and 306b may be phones that use an IP connection to communicate, such as using Voice Over IP (VoIP), telephone 306k may not be able to communicate in such a manner.

In addition to wired connections between locations 304 and networks 314, mobile devices of the enterprise may communicate via any number of mobile carrier networks 310, also referred to as cellular networks, such as mobile carrier networks 310a and 310n (e.g., a first through N^{th} mobile carrier network). For instance, assume that the user of mobile device 302 is present within location 304a. In such a case, mobile device 302 may communicate with a base transceiver station (BTS) 308a when in range and communicate wirelessly via mobile carrier network 310a. If the user of mobile device 302 later travels to another location, such as location 304k, mobile device 302 may communicate with BTS 308b connected to a different mobile carrier network 310n.

According to various embodiments, enterprise telephony system 300 also includes a telephony interconnect service 316 that comprises any number of servers or other computing devices that operate to oversee the various operations of enterprise telephony system 300. For instance, telephony interconnect service 316 may comprise one or more clusters of servers that share resources and a database. Each cluster may have one server designated as a publisher, with the remaining servers designated as subscribers. This allows the publisher to disseminate configurations, Network Time Protocol (NTP) data, etc.

Typically, telephony interconnect service 316 operates as a central call agent that interconnects with mobile carrier networks 310, internet carrier networks 314, and the like, to offer VoIP services to mobile device 302, telephones 306a-306b, and the other communication devices of the enterprise across its various users and locations 304. For instance, consider the cases of telephone calls made to mobile device 302 and telephone calls made from mobile device 302. The endpoints of those calls may be: 1.) users connected to wireline carriers indirectly reachable via a mobile carrier, 2) users registered to the mobile carriers who do not use telephony interconnect service 6, 3.) VoIP users within the same enterprise directly registered to telephony interconnect service 316, and/or 4.) VoIP users associated with other enterprises directly registered to telephony interconnect service 316.

As noted above, the various mobile carrier networks 310 and/or Internet carrier networks 314 may be subject to different governmental regulations. For instance, some countries heavily regulate the termination of VoIP calls through Public Switched Telephone Network (PSTN)-connected telephones. Accordingly, certain functions of telephony interconnect service 316 may be location-specific. In addition, certain locations, such as location 304k, may not even have a connection to a data carrier. As a result, the services provided by telephony interconnect service 316 may be inconsistent across the enterprise.

### Enterprise Telephony Interconnect Service

The techniques introduced herein aid in providing a consistent telephony experience across a geographically diverse enterprise. In some aspects, the techniques herein allow a user to make and receive calls through the telephony system of the enterprise, even when at a location of the enterprise that has no data network connection or an unreliable one. In further aspects, the techniques herein allow an enterprise-enabled mobile device to interface with a fixed telephone at a location of the enterprise, to extend enterprise telephony services to the fixed telephone, reconfigure the telephone as associated with the user of the mobile device, and the like.

Specifically, according to one or more embodiments of the disclosure as described in detail below, a mobile device connected to a cellular network performs a credential exchange with a telephone not connected to an Internet Protocol (IP) network. The mobile device relays, via the cellular network, registration information between the telephone and a telephony interconnect service, based in part on the credential exchange. The mobile device receives an indication of a telephone call associated with a user of the mobile device. The mobile device proxies, via the cellular network, the telephone call between the telephony interconnect service and the telephone.

Illustratively, the techniques described herein may be performed by hardware, software, and/or firmware, such as in accordance with telephony interconnect process 248, which may include computer executable instructions executed by the processor 220 (or independent processor of interfaces 210) to perform functions relating to the techniques described herein.

Operationally, and referring again to FIG. 3, one aspect of the techniques herein is the ability for telephony interconnect service 316 to support convergence between mobile device 302 and a fixed telephone 306. More specifically, assume that mobile device 302 and its user are located in the same office as that of fixed telephone 306a, which is an IP phone. Further, assume that telephone 306a has a primary extension registered with telephony interconnect service 316.

In some embodiments, the user may associate both mobile device 302 and telephone 306a with the same extension, E.164 number, or the like, via telephony interconnect service 316 (e.g., through operation of an application executed by mobile device, web interface, etc.). Once associated, calls made to that extension may cause both mobile device 302 and telephone 306a to ring, giving the user the option of answering the call using mobile device 302 or telephone 306a. This feature is sometimes referred to as ‘outbound anchoring.’

A more complex situation may occur when the user of mobile device 302 dials the E.164 number of a coworker and they miss the call. Since this call will come in from the PSTN, the calling number will be that of mobile device 302. Thus, the call log of the coworker will reflect the PSTN number of mobile device 302. When they attempt to call the user of mobile device 302 back, this will cause only mobile device 302 to ring and not telephone 306a.

In one embodiment, the above situation can be addressed in enterprise telephony system 300 by analyzing the caller ID of all incoming calls across the enterprise. If the caller ID of an incoming call matches that of one of the mobile numbers registered to the enterprise with telephony interconnect service 316, telephony interconnect service 316 may originate the call as if it had come originated from the enterprise line. This can be achieved, for instance, by applying a simple heuristic to the caller ID numbers. As a result, telephone 306a can see and manage the call, as well. This functionality is referred to as ‘inbound anchoring.’

In another embodiment, if someone using a device registered to telephony interconnect service 316 calls the mobile number of mobile device 302, telephony interconnect service 316 can recognize that and divert the call to telephone 306a. In turn, the call may also be sent out via mobile carrier network 310a, so that mobile device 302 also rings. This approach is also another form of outbound anchoring.

The above approaches all assume that the mobile legs of the calls are handled by mobile carrier network 310a. This is important since use of the native dialer of mobile device 302 will leverage the mobile carrier to which mobile device 302 is connected, such as mobile carrier network 310a. In addition, calls originating from strangers in the PSTN are going to arrive over the trunk interface, which can result in both inbound and outbound anchoring.

While the above approaches address cases in which a coworker of the user of mobile device :302 calls from an enterprise telephone, such as telephone 306b, they do not address mobile-to-mobile calls, as the mobile carrier(s) will route the calls directly between mobile devices. In some instances, the enterprise can enter into an agreement with the mobile carrier(s) so that they trap all outbound and inbound calls to a mobile device, so that they are processed by telephony interconnect service 316. As a result, all PSTN and mobile calls associated with mobile device 302 can be captured and processed by telephony interconnect service 316.

Typically, the capabilities mobile carriers are fairly limited, making it challenging to provide enterprise features available through these types of connections. However, mobile carriers also offer data networks. This makes it possible for mobile devices of an enterprise, such as mobile device 302, to execute a client application of telephony interconnect service 316 that is able to communicate with telephony interconnect service 316 via the data network of the mobile carrier. Thus, the client application can register with telephony interconnect service 316 via mobile carrier network 310a and communicate directly with telephony interconnect service 316.

In some instances, another feature of enterprise telephony system 300 allows a user to approach a fixed telephone, such as telephone 306a, and associate the extension of the user with telephone 306a. Typically, this is done by the user entering some credentials into telephone 306a. In turn, telephone 306a uses the provided credentials to retrieve the profile of that user from interconnect service 316. In doing so, calls made to the extension or other number of the user will be sent to telephone 306a. This feature is referred to as extension mobility and is particularly useful in hoteling situations in which an enterprise user only temporarily occupies the office in which telephone 306a is located. This can also be extended across clusters of telephony interconnect service 316, permitting the user to log into their account across different geographic locations 304 (and possibly log into devices that belong to guest enterprises they are visiting).

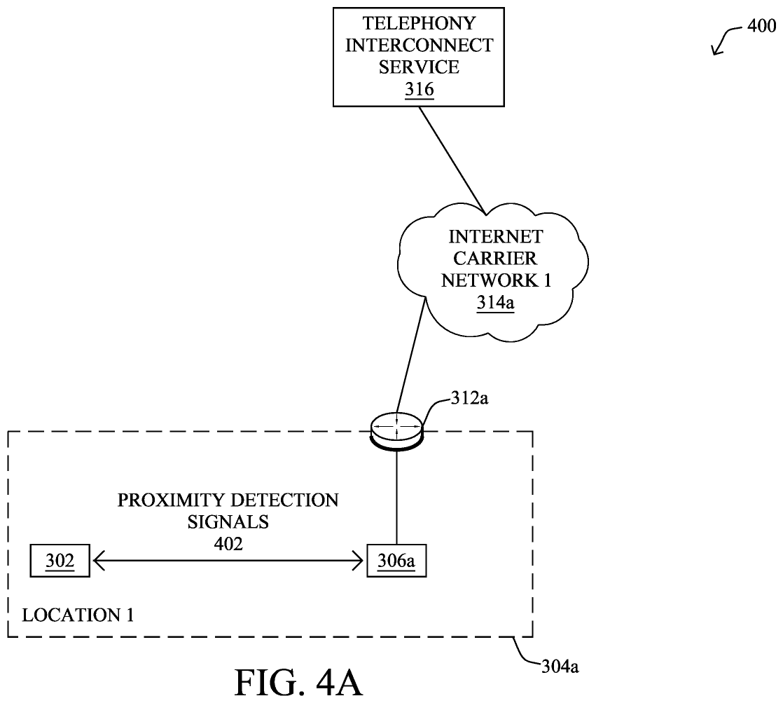

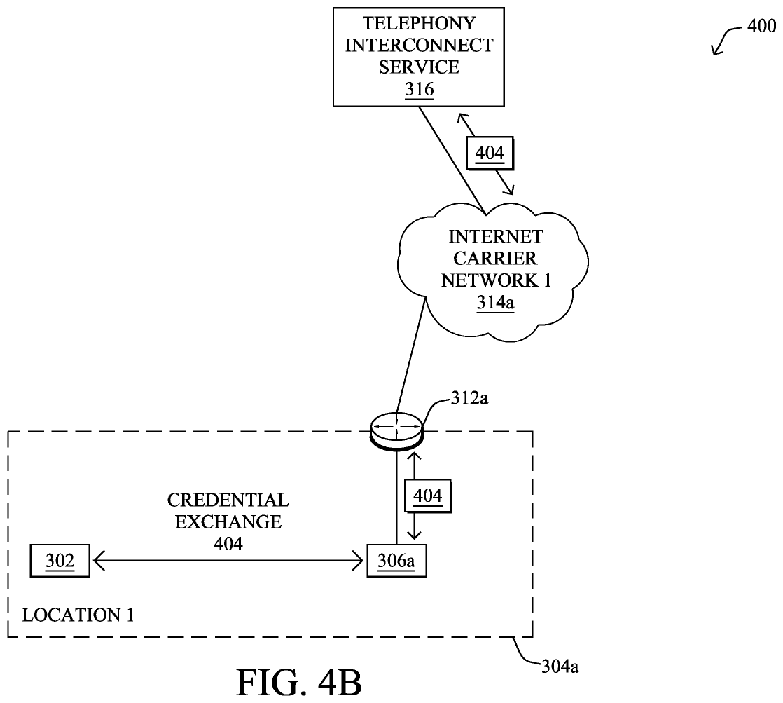

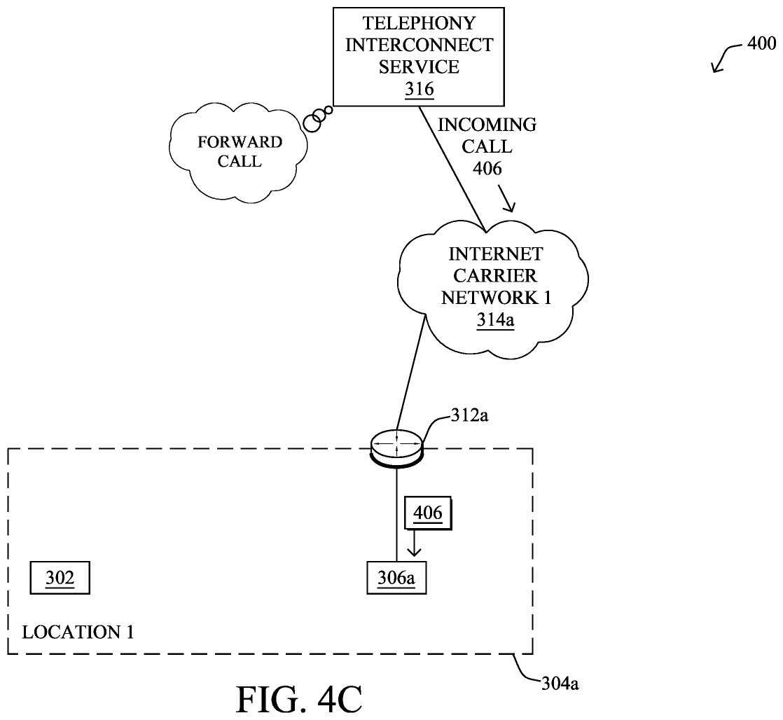

FIGS. 4A-4C illustrate an example 400 of a mobile device interfacing with a telephone, according to various embodiments. In various embodiments, telephone 306a may enter into a standby mode/quiescent state after a certain period of disuse. When registered with the user of mobile device 302, telephone 306a may ignore off-hook requests and block other phone interactions. Furthermore, if the call agent of telephony interconnect service 316 offers a call to telephone 306a, telephone 306a may not offer the call to the user, in one embodiment. In another embodiment, telephony interconnect service 316 may be notified of telephone 306a being in its quiescent state and not offer the call to it, in the first place.

According to various embodiments, mobile device 302 and telephone 306a may employ a proximity detection mechanism, to recognize when mobile device 302 and telephone 306a are within a certain range of one another. To do so, either or both of mobile device 302 and telephone 306a may leverage proximity detection signals 402. For instance, proximity detection signals 402 may take the form of ultrasound/ultrasonic signals, near field communications (NFC) signals, other radio frequency (RF) or light signals, or the like. Using this signaling, telephone 306a will recognize that mobile device 302 is within range and awake.

As shown in FIG. 4B, once telephone 306a is awake, mobile device 302 and telephone 306a may perform a credential exchange 404. In general, credential exchange 404 may be performed wirelessly, such as using the same approach as the proximity detection, Bluetooth, Wi-Fi, or the like, to verify their respective identities to each other. For instance, credential exchange 404 may entail mobile device 302 and telephone 306a exchanging security keys, change-response requests, etc.

In FIG. 4C, after telephone 306a has awakened and verified the credentials of mobile device 302, it may become eligible again to receive an incoming call 406 via telephony interconnect service. In addition, calls dialed from within the application of device 302 can trigger the call to originate from telephone 306a, instead. Further, as a result of this proximity-based wakeup, telephone 306a is essentially protected from use by interlopers while its registered user is away.

In another scenario, assume that the user of mobile device 302 is not currently logged into telephone 306a, which may be associated with either a different user or no user at all. In such cases, the same proximity detection depicted in FIG. 4A may be leveraged and credential exchange 404 performed, as shown in FIG. 4B. Here, since the user of mobile device 302 is not logged into telephone 306a, credential exchange 404 may also include the login information of the user, which may be passed from telephone 306a to telephony interconnect service 316 for purposes of configuring telephone 306a with the profile of that user. For instance, the client application for telephony interconnect service 316 executed by mobile device 302 may pass its login information wirelessly to telephone 306a, once the two devices have validated their respective identities. This information can then be passed to telephony interconnect service 316 either via telephone 306a or, alternatively, by mobile device 302.

The login of the user of mobile device 302 to telephone 306a may occur on a single cluster of telephony interconnect service 316 or across multiple clusters. In either case, telephony interconnect service 316 may associate the exchange or other number of the user of mobile device 302 with telephone 306a, download any preferences or other configurations associated with the user to telephone 306a (e.g., saved contacts, etc.).

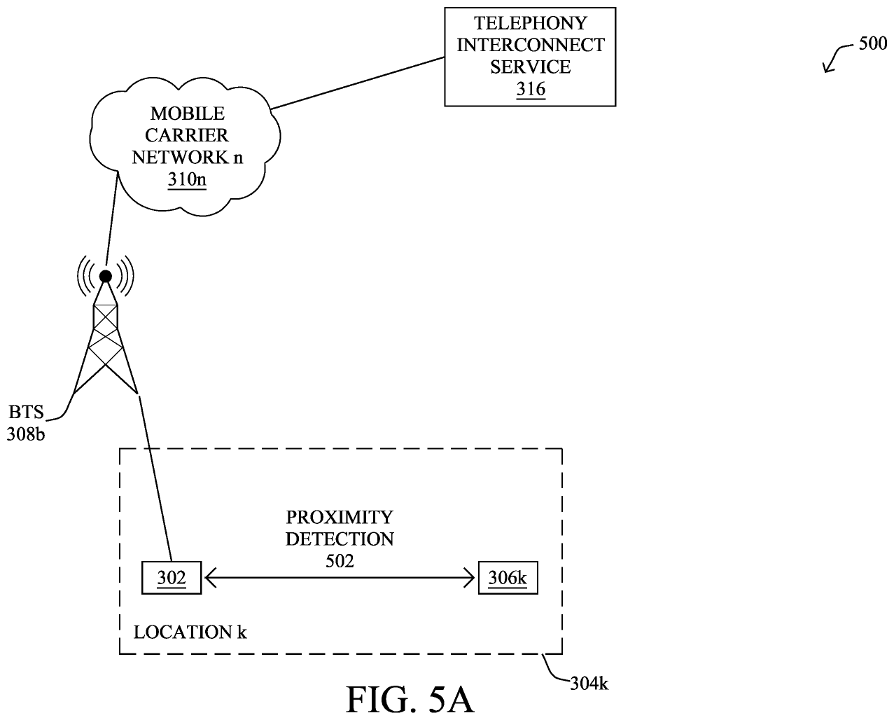

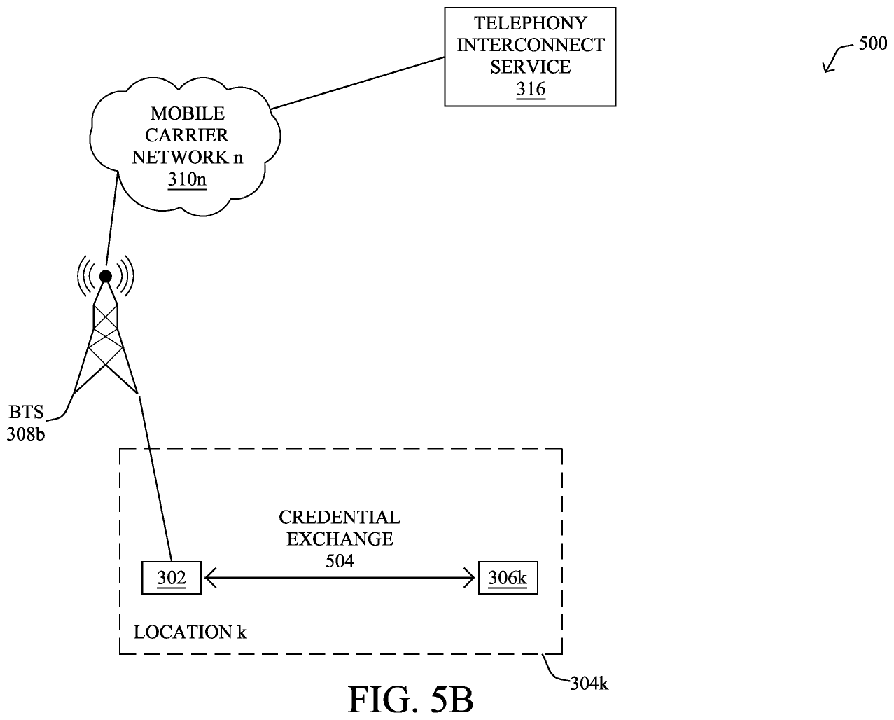

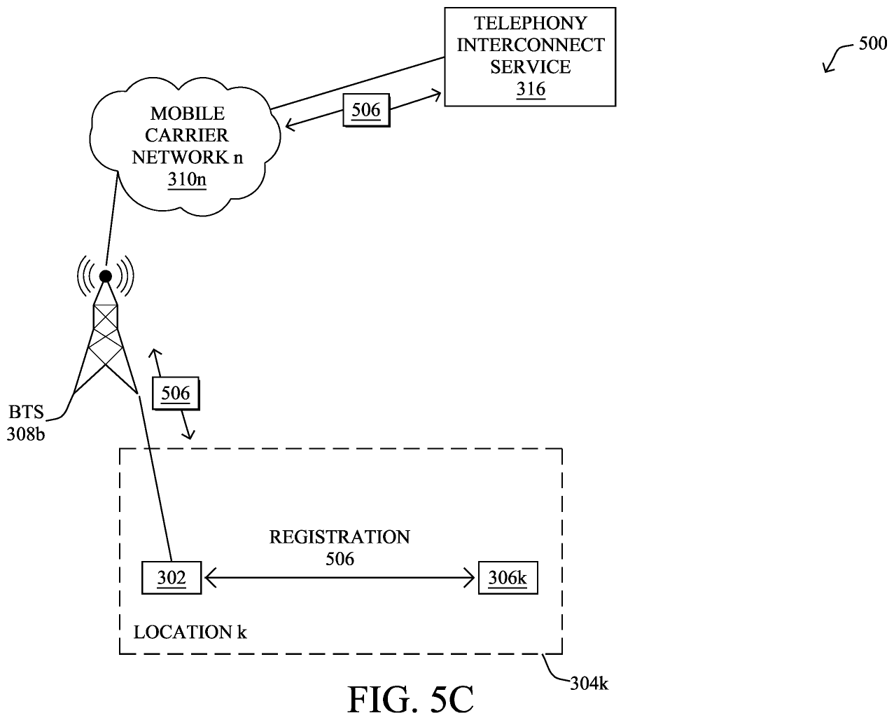

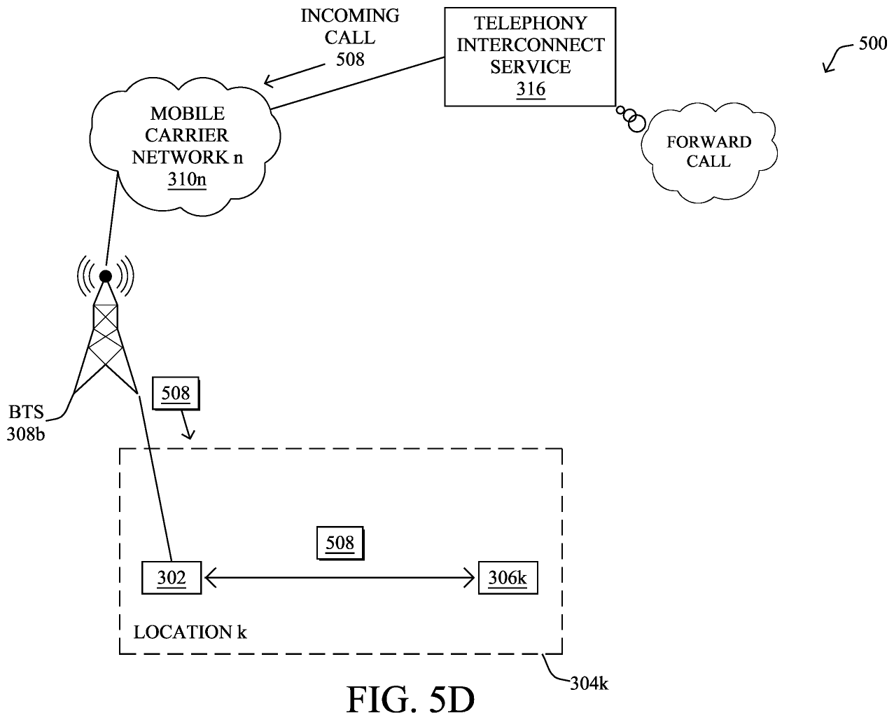

FIGS. 5A-5D illustrates an example 500 of a mobile device proxying a call with a telephone, according to various embodiments. To further illustrate the techniques herein, now consider the case in which the user of mobile device 302 travels to location 304k of the enterprise that does not have an external connection to a data network, such as an Internet carrier network. Thus, telephone 306k may not even be registered with telephony interconnect service 316 and may only be connected to a wired telephone network.

As shown in FIG. 5A, when mobile device 302 comes within proximity of telephone 306k, either or both may perform proximity detection 502 in a manner similar to that described previously with respect to FIG. 4A. This allows telephone 306k to awaken from its standby mode.

In FIG. 5B, once telephone 306k has awakened, mobile device 302 and telephone 306k may perform credential exchange 504, in various embodiments. This may be performed, for instance, in a manner similar to that of FIG. 4B, to establish trust between mobile device 302 and telephone 306k.

In FIG. 5C, according to various embodiments, telephone 306k may pair wirelessly with mobile device 302, allowing it to perform registration 506 with telephony interconnect service 316. During registration 506, data packets, including call agent registration packets, can relay through mobile device 302 and over mobile carrier network 310m, to reach telephony interconnect service 316. Once telephone 306k is registered, this allows telephony interconnect service 316 to associate telephone 306k with the user of mobile device 302, based on the login information of the user. In doing so, telephony interconnect service 316 may associate the extension or other number of the user of mobile device 302 with telephone 306k. In addition, telephony interconnect service 316 may push the profile information (e.g., configurations ser to telephone 306k, using mobile device 302 as an intermediary.

When an incoming call 508 is sent to mobile device 302, the user of mobile device 302 may display, via a display of mobile device 302, indicia regarding incoming call 508 and prompt the user with any or all of the following options:

1.) answer the call directly via mobile device 302 (e.g., via the client application executed by mobile device 302, its native calling, etc.); or

2.) answer the call using the registration of telephone 306k, as proxied via mobile device 302.

In other words, the user of mobile device 302 may, in some instance, opt to receive call 508 via telephone 306k (e.g., by issuing a command via the display of mobile device 302), thereby allowing the user to take call 508 using telephone 306k.

In cases in which telephone 306k receives an incoming call for the user of mobile device 302, mobile device 302 may rewrite the Session Description Protocol (SDP) data from telephone 306k to indicate the mobile IP address of mobile device 302 and then relay any incoming voice packets to telephone 306k, in some embodiments.

A similar process may occur for outgoing calls, in further embodiments.

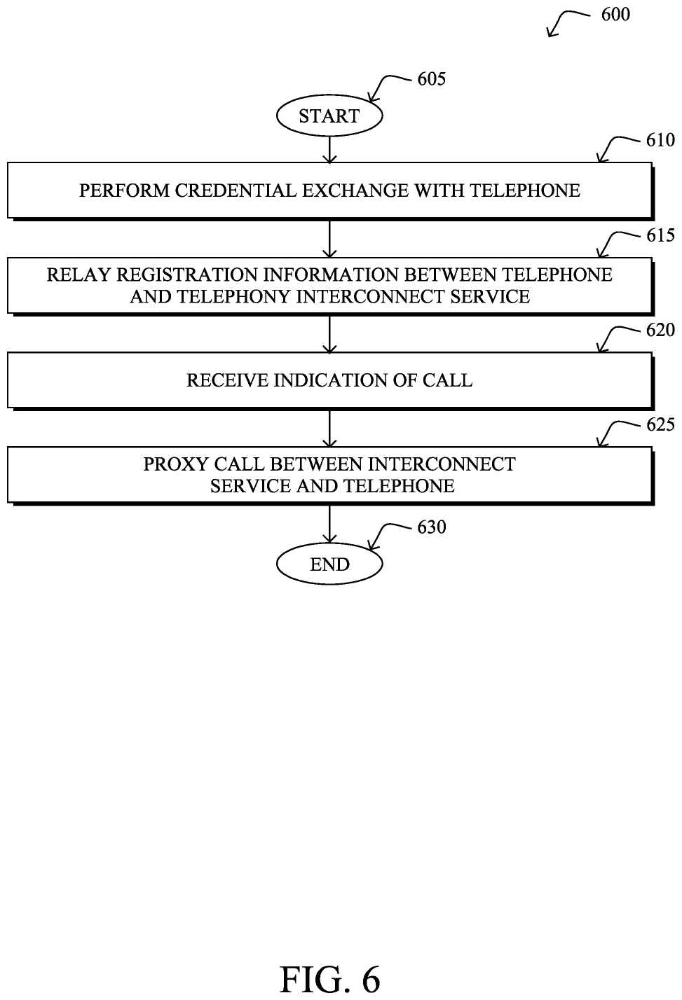

FIG. 6 illustrates an example simplified procedure for performing a telephone call, in accordance with one or more embodiments described herein. For example, a non-generic, specifically configured device (e.g., device 200), such as a mobile device (e.g., mobile device 302) may perform procedure 600 by executing stored instructions (e.g., process 248). The procedure 600 may start at step 605, and continues to step 610, where, as described in greater detail above, the device may perform a credential exchange with a telephone not connected to an IP network. As would be appreciated, in some instances, the telephone may be located in an office building or other location that either has an unreliable Internet connection or may even lack switches, firewalls, session border controllers (SBCs), or other computer networking equipment. The exchange may be made wirelessly, in some embodiments, such as via Bluetooth, near field communication (NFC), Wi-Fi, ultrasound, or the like. In some embodiments, the exchange may be initiated after the device indicates that the mobile device is in proximity of the telephone, to awaken the telephone from a standby state, using any of these communication approaches.

At step 615, as detailed above, the device may relay, via the cellular network, registration information between the telephone and a telephony interconnect service, based in part on the credential exchange. More specifically, once the device and the telephone have proven their identities to one another, the device may send data to the telephony interconnect service on behalf of the telephone, such as call registration packets, extension mobility information to associate the device and the telephone with a single telephone number or extension, retrieve settings associated with the user of the device (e.g., preferences, favorite contacts, etc.), and the like.

At step 620, the device may receive an indication of a telephone call associated with the user of the device, as described in greater detail above. In some embodiments, the device may receive the indication from the telephone. In other embodiments, the device may receive the indication via the cellular network, such as via an application executed by the device and associated with the telephony interconnect service, etc. In turn, the device may display indicia regarding the telephone call via a display of the device, after receiving the indication of the telephone call, and thereafter receive, via the display of the mobile device, a command to proxy telephone call between the telephony interconnect service and the telephone. Other options available to the user via the display may be to accept the call using the device itself.

At step 625, as detailed above, the device may proxy, via the cellular network, the telephone call between the telephony interconnect service and the telephone. For instance, in one embodiment, the device may rewrite SDP data from the telephone to indicate an IP address of the device and relaying incoming voice packets of the telephone call from the device to the telephone. In other words, the device may act as an intermediary between the telephony interconnect service and the telephone, thereby allowing the telephone to function as an IP-connected enterprise telephone, despite the fact that the telephone lacks such a connection on its own. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce techniques that allow a mobile device and a static telephone to interact as part of an enterprise telephony system. In some aspects, the techniques herein allow the functions of the enterprise telephony system to be extended to the static telephone, even when it does not have a reliable or existing wired connection to the telephony interconnect service. In further aspects, the mobile device and the telephone may initiate a credential exchange when the two are within proximity of one another, allowing the telephone to remain in a sleeping state until woken up by the mobile device. Such an exchange may also facilitate associating the mobile device and the telephone with one another via the telephony interconnect service, to allow calls to be made to both using a single number or extension, configuring the telephone with settings associated with the user of the mobile device, and the like.

While there have been shown and described illustrative embodiments that provide for an enterprise telephony service, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
performing, by a mobile device connected to a cellular network, a credential exchange with a telephone not connected to an Internet Protocol (IP) network;
relaying, by the mobile device and via the cellular network, registration information between the telephone and a telephony interconnect service, based in part on the credential exchange;
receiving, at the mobile device, an indication of a telephone call associated with a user of the mobile device; and
proxying, by the mobile device and via the cellular network, the telephone call between the telephony interconnect service and the telephone.

2. The method as in claim 1, wherein the credential exchange with the telephone is performed wirelessly.

3. The method as in claim 1, further comprising:
indicating, by the mobile device, that the mobile device is in proximity of the telephone, to awaken the telephone from a standby state.

4. The method as in claim 3, wherein the mobile device indicates that it is in proximity of the telephone using near field communication or ultrasound.

5. The method as in claim 1 wherein the mobile device receives the indication of the telephone call from the telephone, and wherein proxying the telephone call between the telephony interconnect service and the telephone comprises:
rewriting Session Description Protocol (SDP) data from the telephone to indicate an IP address of the mobile device; and
relaying incoming voice packets of the telephone call from the mobile device to the telephone.

6. The method as in claim 1, wherein relaying, by the mobile device and via the cellular network, the registration information between the telephone and the telephony interconnect service, based in part on the credential exchange, comprises:
associating, via the telephony interconnect service, the mobile device and the telephone with a single telephone number or extension.

7. The method as in claim 1, further comprising:
displaying, via a display of the mobile device, indicia regarding the telephone call, after receiving the indication of the telephone call; and
receiving, via the display of the mobile device, a command to proxy telephone call between the telephony interconnect service and the telephone.

8. The method as in claim 1, wherein relaying, by the mobile device and via the cellular network, the registration information between the telephone and the telephony interconnect service comprises:
relaying settings associated with the user of the mobile device between the telephony interconnect service and the telephone.

9. The method as in claim 1, wherein the mobile device receives the indication of the telephone call associated with the user of the mobile device via an application executed by the mobile device that uses a data connection with the cellular network.

10. An apparatus, comprising:
one or more network interfaces to communicate via a cellular network;
a processor coupled to the one or more network interfaces and configured to execute one or more processes; and
a memory configured to store a process that is executable by the processor, the process when executed configured to:
perform a credential exchange with a telephone not connected to an Internet Protocol (IP) network;
relay, via the cellular network, registration information between the telephone and a telephony interconnect service, based in part on the credential exchange;
receive an indication of a telephone call associated with a user of the apparatus; and
proxy, via the cellular network, the telephone call between the telephony interconnect service and the telephone.

11. The apparatus as in claim 10, wherein the credential exchange with the telephone is performed wirelessly.

12. The apparatus as in claim 10, wherein the process when executed is further configured to:
indicate that the apparatus is in proximity of the telephone, to awaken the telephone from a standby state.

13. The apparatus as in claim 12, wherein the apparatus indicates that it is in proximity of the telephone using near field communication or ultrasound.

14. The apparatus as in claim 10, wherein the apparatus receives the indication of the telephone call from the telephone, and wherein the process when executed is configured to proxy the telephone call between the telephony interconnect service and the telephone by:
rewriting Session Description Protocol (SDP) data from the telephone to indicate an IP address of the apparatus; and
relaying incoming voice packets of the telephone call from the apparatus to the telephone.

15. The apparatus as in claim 10, wherein the process when executed is configured to relay, via the cellular network, the registration information between the telephone and the telephony interconnect service, based in part on the credential exchange, by:
associating, via the telephony interconnect service, the apparatus and the telephone with a single telephone number or extension.

16. The apparatus as in claim 10, wherein the process when executed is further configured to:
display indicia regarding the telephone call, after receiving the indication of the telephone call; and
receive a command to proxy telephone call between the telephony interconnect service and the telephone.

17. The apparatus as in claim 10, wherein the process when executed is configured to relay, via the cellular network, the registration information between the telephone and the telephony interconnect service by:
relaying settings associated with the user of the apparatus between the telephony interconnect service and the telephone.

18. The apparatus as in claim 10, wherein the apparatus receives the indication of the telephone call associated with the user of the apparatus via an application executed by the apparatus that uses a data connection with the cellular network.

19. The apparatus as in claim 10, wherein the apparatus comprises a mobile phone.

20. A tangible, non-transitory, computer-readable medium storing program instructions that cause a mobile device connected to a cellular network to execute a process comprising:
performing, by the mobile device, a credential exchange with a telephone not connected to an Internet Protocol (IP) network;
relaying, by the mobile device and via the cellular network, registration information between the telephone and a telephony interconnect service, based in part on the credential exchange;
receiving, at the mobile device, an indication of a telephone call associated with a user of the mobile device; and
proxying, by the mobile device and via the cellular network, the telephone call between the telephony interconnect service and the telephone.
